(19) United States
(12) Patent Application Publication
(10) Pub. No.: US 2026/0258921 A1
(43) Pub. Date: Sep. 3, 2026

(54) LIGHTING DEVICE AND RELATED METHODS

(71) Applicant: Velaflame, LLC, Saratoga Springs, UT (US)

(72) Inventors: Kyler Tolman, Ann Arbor, MI (US); Ken Bretschneider, Saratoga Springs, UT (US); Nathan Jensen, Santa Ana, CA (US); Adam Rollins, Wake Forest, NC (US)

(73) Assignee: Velaflame, LLC, Saratoga Springs, UT (US)

(21) Appl. No.: 19/553,302

(22) Filed: Feb. 28, 2026

Related U.S. Application Data
(60) Provisional application No. 63/765,585, filed on Mar. 1, 2025.

(51) Int. Cl. F21S 10/04; F21S 9/02; F21V 5/04; F21V 7/00; F21V 14/08

(52) U.S. Cl. CPC F21S 10/046; F21S 9/02; F21V 5/048; F21V 7/0091; F21V 14/08

(57) ABSTRACT

A lighting device is disclosed that mimics the appearance of a flame. The device includes a flame display element positioned above a light source, a lighting subsystem configured to generate a light output, and a reflector arranged to collect and direct the light output upward onto the flame display element, optionally through a lens. In certain embodiments, the flame display element extends through an opening in the lens and is movably coupled by an integrated hinge or a separate hinge. A movement subsystem moves the flame display element to emulate flame motion, for example, using a magnet coupled to the flame display element and an electromagnet selectively activated to generate attractive and/or repulsive forces. A power subsystem powers the lighting and movement subsystems and may convert alternating current to direct current.

### RELATED APPLICATIONS

This application claims priority to U.S. Provisional Patent Application No. 63/765,585, filed on Mar. 1, 2025, and titled LIGHTING DEVICE AND RELATED MATHODS.

### TECHNICAL FIELD

The present disclosure relates to a lighting device and related methods. More particularly but not exclusively, the invention relates to a lighting device that mimics the appearance of a flame.

### BRIEF DESCRIPTION OF THE DRAWINGS

Some embodiments of the present invention are illustrated as examples and are not limited by the figures of the following drawings, in which like references may indicate similar elements and in which:

FIG. 1A depicts a front view of a lighting device consistent with embodiments of the present disclosure.

FIG. 1B depicts a cross-sectional view of the lighting device of FIG. 1A, comprising a flame display element, a light source, and a plurality of components to redirect light from a light source onto a reflector and to cause the reflector to move consistent with embodiments of the present disclosure.

FIG. 1C illustrates a cross-sectional view of the lighting device of FIG. 1A and comprises a central light source and a reflector/lens assembly to redirect light rays to illuminate a flame-shaped display consistent with embodiments of the present disclosure.

FIG. 2 illustrates a cross-sectional view of a lighting device comprising multiple or offset light sources and configured to redirect light to the flame-shaped element consistent with embodiments of the present disclosure.

FIG. 3 illustrates a cross-sectional view of a lighting device in which a reflector is configured to redirect light rays from a light source to a flame display element with a total internal reflection lens consistent with embodiments of the present disclosure.

FIG. 4 illustrates a cross-sectional view of the lighting device comprising multiple or offset light sources directed through a total internal reflection device consistent with embodiments of the present disclosure.

FIG. 5 illustrates a functional block diagram of a plurality of subsystems within a lighting device consistent with embodiments of the present disclosure.

FIG. 6A illustrates certain details of a flame display element and hinge pin, along with a magnet to a coupling element consistent with embodiments of the present disclosure.

FIG. 6B illustrates a conceptual representation of a coupling element to moveably connect a hinge pin consistent with embodiments of the present disclosure.

FIG. 6C illustrates a conceptual representation of a coupling element to receive a magnet consistent with embodiments of the present disclosure.

FIG. 7A illustrates a perspective view of a freestanding lighting device consistent with embodiments of the present disclosure.

FIG. 7B illustrates a partially exploded view of the freestanding lighting device of FIG. 7A consistent with embodiments of the present disclosure.

FIG. 7C illustrates a cross-sectional view taken along the line 7C of the freestanding lighting device illustrated in FIG. 7A and consistent with embodiments of the present disclosure.

FIG. 8A illustrates a perspective view of a freestanding lighting device and consistent with embodiments of the present disclosure.

FIG. 8B illustrates a cross-sectional view taken along the line 8B of the freestanding lighting device illustrated in FIG. 8A and consistent with embodiments of the present disclosure.

### DETAILED DESCRIPTION

The present application discloses various embodiments of lighting devices that mimic the appearance of a flame. In various embodiments, light may be generated in a color that mimics a flame, and a moving flame display element may simulate the movement characteristics of a flame. Lighting devices consistent with the present disclosure may be used in a variety of applications (e.g., indoor and outdoor light fixtures, permanent or temporary applications) and in a variety of form factors (e.g., light bulbs, night lights, lighting fixtures, flashlights, accent lights, decorative lights, strand lights, etc.).

Various lighting devices consistent with the present disclosure may include a light source, a control system, a casing, and a power system. The light source may direct light toward a flame display element. In various embodiments, a plurality of Red-Green-Blue-White (RGBW) light-emitting diodes (LEDs) may generate the light directed by the lighting elements. A control system may establish parameters of the system (e.g., on/off status, light color, brightness, movement of the reflector, etc.). The color and intensity of the lighting devices varies over time to mimic a glow of a candle body. A power supply may receive power from an external source and condition the power for use by the lighting device.

In some embodiments, various parameters of a lighting device consistent with the present disclosure may be controlled using a lighting controller or mobile application. Such parameters may include light color, light patterns, and/or reflector movement. The lighting device may include a hardwired or wireless interface to facilitate communication with the control device. Such an interface may support DMX 512, Wireless DMX protocol, Bluetooth communication (IEEE 802.15), including Bluetooth Low Energy and Bluetooth mesh, or Wi-Fi (IEEE 802.11).

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

A number of techniques and steps are disclosed in connection with various embodiments. Each of these has individual benefits, and each can also be used in conjunction with one or more, or in some cases all, of the other disclosed techniques. Accordingly, for the sake of clarity, this description does not repeat every possible combination of the individual steps. Nevertheless, the specification and claims should be read with the understanding that such combinations are within the scope of the invention and the claims. The present disclosure discloses specific embodiments, and does not limit the claims as understood by one of skill in the art.

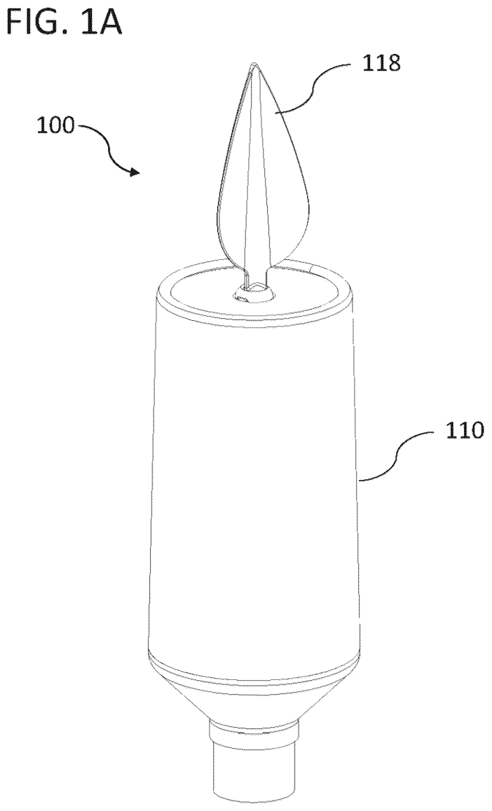

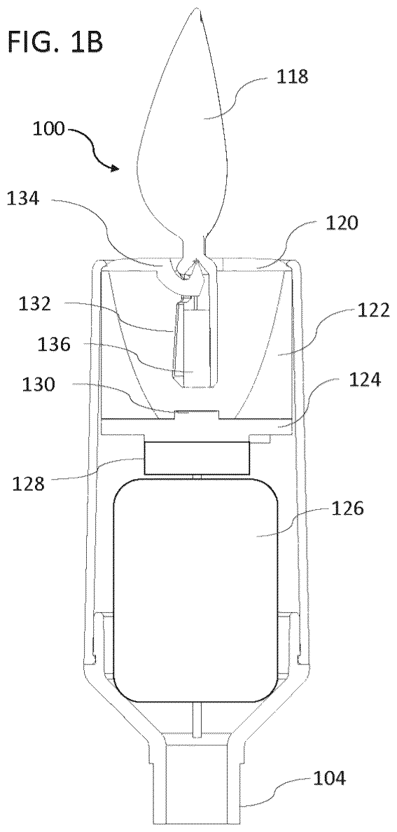

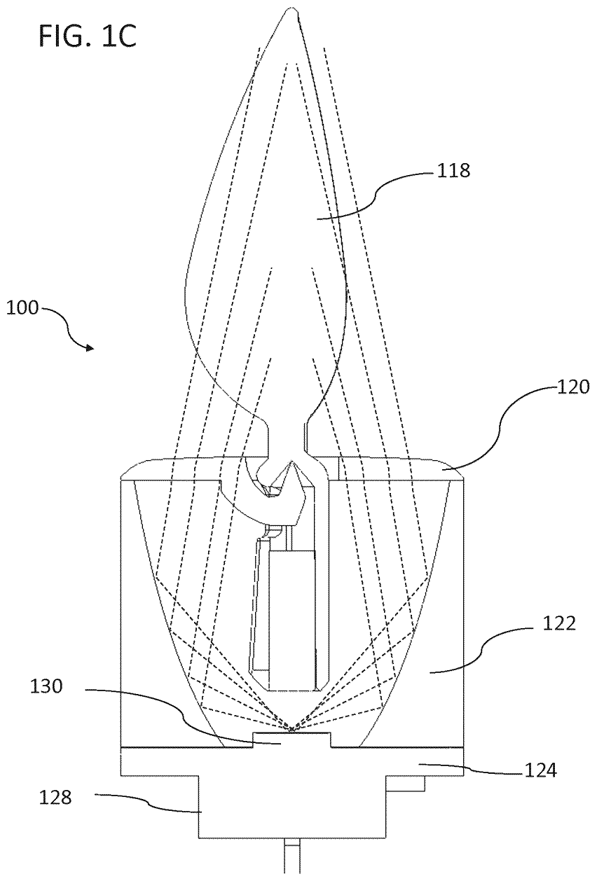

FIG. 1A illustrates a front view of a lighting device 100 comprising a body 110, a flame display element 118, a light source, and a plurality of components to redirect light from the light source onto flame display element 118 and to cause flame display element 118 to move consistent with embodiments of the present disclosure. Flame display element 118 may be disposed at the top of lighting device 100. In various embodiments, flame display element 118 may be moved to mimic the movement of a flame atop a candle. Flame display element may comprise three sides offset by approximately 120 degrees.

FIG. 1B depicts a cross-sectional view of lighting device 100 of FIG. 1A and comprising a flame display element 118, a light source 130, and a plurality of components to redirect light from light source 130 onto the flame display element and to cause it to move consistent with embodiments of the present disclosure. A lens 120 may be disposed at the top of body 110, and flame display element 118 may extend through lens 120. In some embodiments, lens 120 may comprise discretized prismatic elements. Discretized prismatic elements may disperse light across flame display element 118.

Flame display element 118 may be mounted on an integrated hinge 134 that is part of lens 120. Of course, a hinge may be provided in alternative embodiments that is separate from lens 120. Integrated hinge 134 allows for a movable connection between flame display element 118 and other components of lighting device 100. A magnet retention element 132 may be coupled to flame display element 118 and may be used to cause flame display element 118 to move by interaction with an electromagnet 128 positioned within lighting device 100. Electromagnet 128 may be selectively activated to generate an attractive or repulsive force. Such attractive or repulsive forces may interact with a magnet 136 disposed within magnet retention element 132.

A reflector 122 may redirect light emitted from a light source 130 toward flame display element 118. Reflector 122 may be shaped to collect light from light source 130 and redirect the light through lens 120 onto flame display element 118. As illustrated in FIG. 1C, light rays proceeding on innumerable paths may be directed to flame display element 118 and may create a soft light that mimics the light given off by a candle.

A power subsystem 126 may be disposed within body 110 and may provide power to components of lighting device 100. In some embodiments, power subsystem 126 may comprise a direct current power supply, such as a battery or external power supply. Alternatively, lighting device 100 may receive power from an alternating current source, and power subsystem 126 may convert the alternating current to direct current. Power may be provided, among other things, to light source 130 and electromagnet 128.

In some embodiments, a base 104 may be used to couple lighting device 100 to a receptacle (not shown). In the illustrated embodiment, base 104 is configured to couple to an E12 bulb base (a/k/a a candelabra base). Electricity may be drawn from the receptacle to power lighting device 100. In one embodiment, a power supply subsystem may be configured to convert 120V AC power to DC power for use by lighting device 100. The electrical components that make up the power supply may be integrated into a PCB 124, which also includes other electrical components.

In the illustrated embodiment, light source 130 is disposed on PCB 124. In such an embodiment, light source 130 may comprise a surface-mounted LED device (“SMD”). Of course, other types of light devices may be used in other embodiments. Additional elements disposed on PCB 124 may include a communication subsystem configured to enable lighting device 100 to be controlled by an external device (not shown), such as an application operating on a mobile computing device or external lighting controller.

In some embodiments, various parameters of a lighting device consistent with the present disclosure, such as lighting device 100, may be controlled using a mobile application. Such parameters may include light color, light patterns, and/or reflector movement. The lighting device may include an interface to communicate with the application. Such an interface may support communication using Bluetooth (IEEE 802.15) or Wi-Fi (IEEE 802.11).

FIG. 1C illustrates a cross-sectional view of the lighting device of FIG. 1A and that comprises a central light source (i.e., light source 130) and a reflector/lens assembly to redirect light rays to illuminate flame display element 118 consistent with embodiments of the present disclosure. A plurality of light rays are depicted as dashed lines. Reflector 122 may be shaped to redirect light emanating from light source 130 upward toward lens 120. Lens 120 may be configured to again redirect the plurality of light rays onto flame display element 118. As one of skill in the art will appreciate, the specific light paths illustrated using dashed lines are merely representative of innumerable paths. The innumerable paths between light source 130 and flame display element 118 may create an effect that mimics the soft light of a candle.

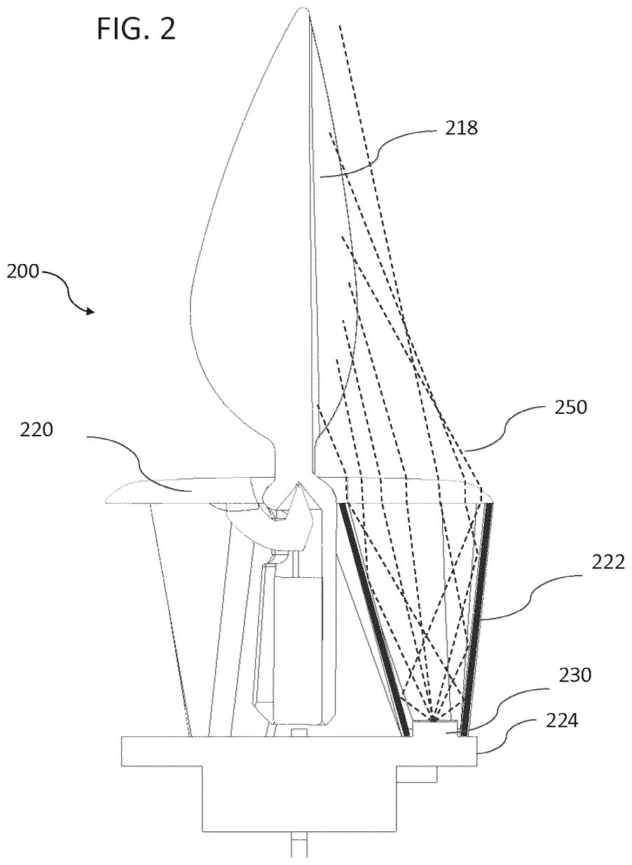

FIG. 2 illustrates a cross-sectional view of a lighting device 200 comprising an offset light source 230 and configured to redirect light to a flame display element 218 consistent with embodiments of the present disclosure. A reflector 222 may be disposed above offset light source 230. Reflector 222 may utilize a mirrored surface or the phenomenon of total internal reflection (“TIR”) to redirect the light emitted by the offset light source 230. In the illustrated embodiment, offset light source 230 is disposed toward the edge of a PCB 224. Reflector 222 directs the light rays toward a lens 220 that again redirects the light rays onto flame display element 218. In the illustrated embodiment, lens 220 has a convex shape. Lens 220 may redirect light rays (e.g., ray 250) that are farthest toward the outer edge of lens 220 the most sharply inwardly toward flame display element 218.

As may be appreciated, the configuration illustrated in FIG. 2 may accommodate a plurality of light sources disposed around the perimeter of PCB 224. Additional light sources may allow greater luminosity and/or provide additional features compared to a single light source. For example, a plurality of light sources may generate light of slightly different colors to broaden the light spectrum created by lighting device 200.

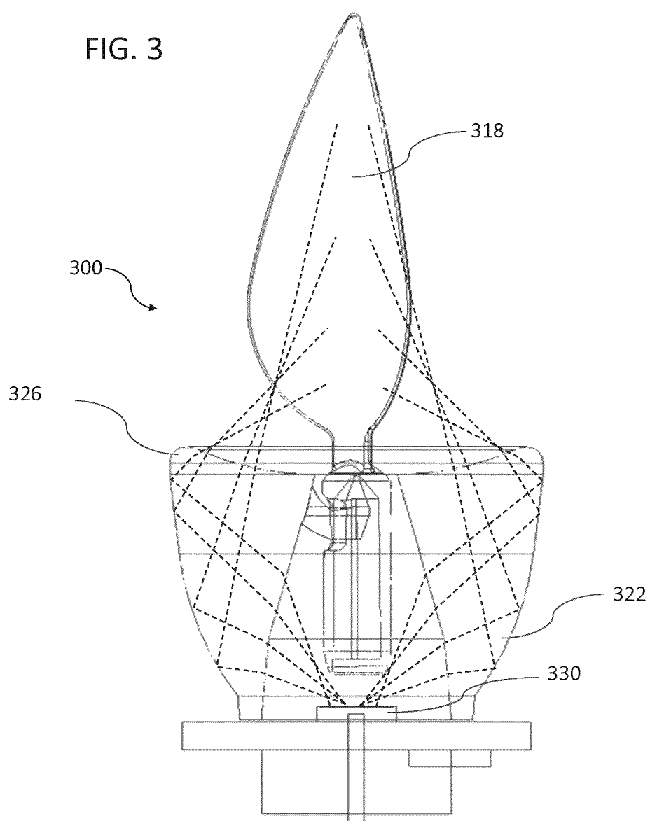

FIG. 3 illustrates a cross-sectional view of a lighting device 300 comprising a concave lens 326 configured to redirect light rays from a light source 330 to a flame display element with a total internal reflection lens consistent with embodiments of the present disclosure. The dashed lines represent potential paths of light rays, which are redirected by the reflective surface 322, which is a part of the total internal reflection lens 326 to provide uniform coverage across the surface of flame display element 318. A lens used in light devices consistent with the present disclosure may embody a wide range of shapes and optical properties. As one of skill in the art will appreciate, specific geometries are provided only by way of example.

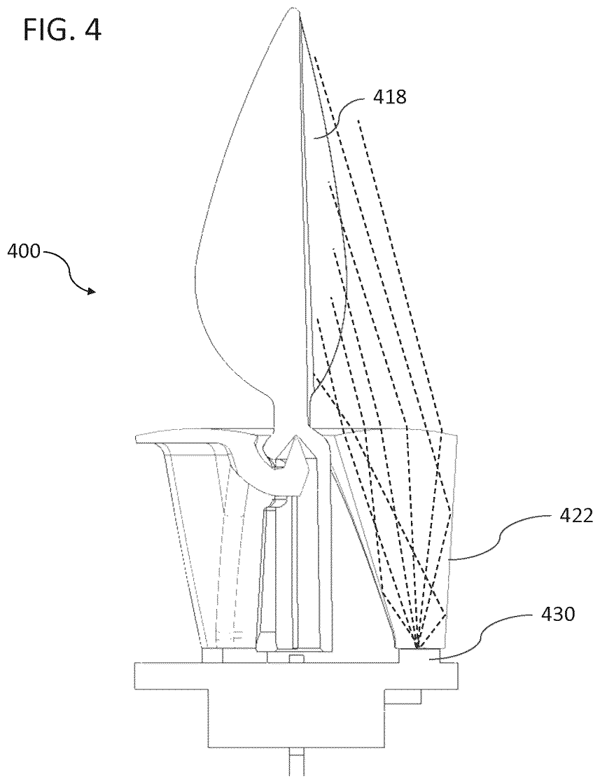

FIG. 4 illustrates a cross-sectional view of the lighting device 400 comprising a TIR reflector and integrated lens 422 consistent with embodiments of the present disclosure. Lighting device 400 may include an offset light source 430. Light from offset light source 430 may be directed to TIR reflector and integrated lens 422. The combination of a reflector and lens may offer certain advantages that will be appreciated by one of skill in the art. Such advantages may include facilitating manufacture.

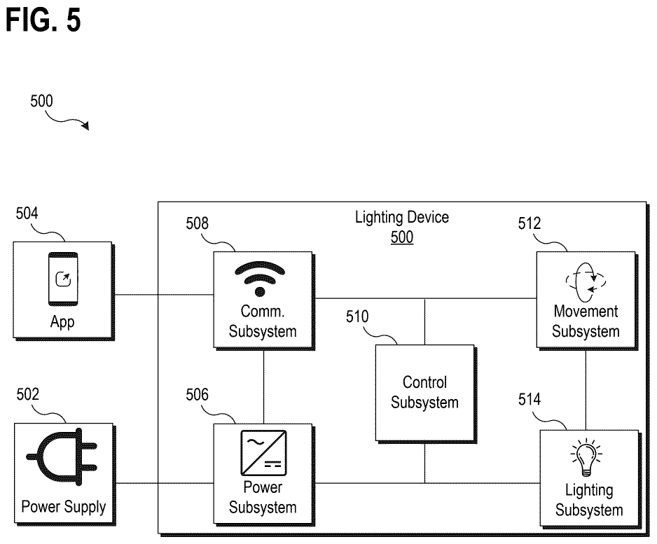

FIG. 5 illustrates a functional block diagram of a plurality of subsystems within a lighting device 500 consistent with embodiments of the present disclosure. Lighting device 500 may receive alternating electrical current from a power supply 502. A power subsystem 506 may convert the alternating current to direct current suitable for use by a communication subsystem 508, a control subsystem 510, a movement subsystem 512, and a lighting subsystem 514. In one specific embodiment, power subsystem 506 may receive 120-volt, 60 Hertz alternating current and output 5-volt direct current.

Communication subsystem 508 may communicate with an application 504. Although a mobile application is specifically illustrated, communication subsystem 508 may receive communication from various types of devices and using various communication technologies and protocols. Application 504 may allow a user to control various parameters of lighting device 500 (e.g., color, brightness, movement, etc.).

Control subsystem 510 may control various aspects of lighting device 500. In some embodiments, control subsystem 510 may generate electrical signals that result in a desired action, while in other embodiments, control subsystem 510 may issue commands or instructions to other subsystems. Control subsystem 510 may include a processing element and computer-readable media (both transitory and non-transitory) to implement such functionality.

Lighting subsystem 514 may generate and direct light. In one specific embodiment, lighting subsystem 514 may include a plurality of LEDs to generate light, a plurality of lenses or reflectors to direct the light, and a flame display element to reflect the light. Lighting subsystem 514 may generate different colors and brightness and may implement other functions to mimic the appearance of a flame.

Movement subsystem 512 may generate movement to mimic the motion of a flame. In one embodiment, a three-sided flame display element may be coupled to a magnet, and the magnet may interact with a variable electromagnetic field generated by an electromagnet. Selectively activating the electromagnet may induce motion to mimic the appearance of a flame.

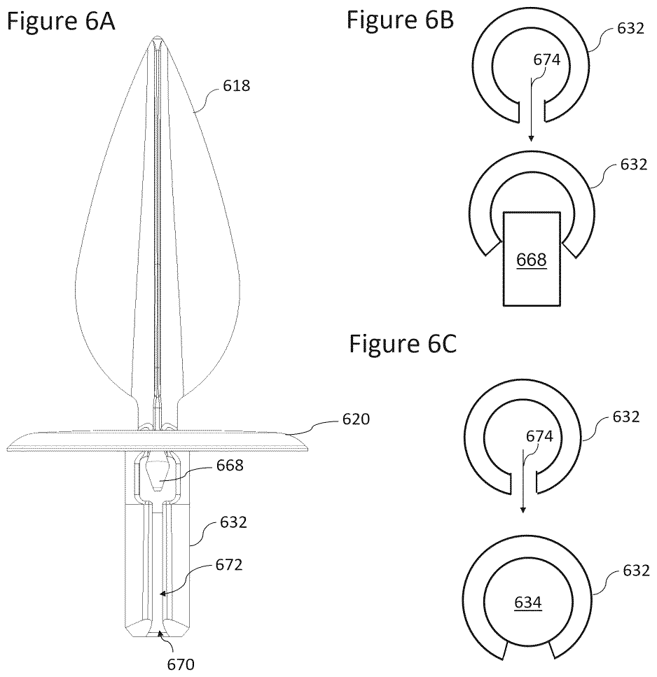

FIG. 6A illustrates certain details of a flame display element 618, a hinge pin 668, and a coupling element 632 consistent with embodiments of the present disclosure. Flame display element 618 may extend through an opening in a lens 620. Hinge pin 668 may be connected to lens 620, and in some embodiments, may be integrally formed with lens 620. An aperture 670 in flame display element 618 may be aligned with hinge pin 668, and flame display element 618 may be pushed down and slid along a channel 672 such that hinge pin 668 slides into place. Aperture 670 may also receive a magnet (not shown). The magnet may be retained within channel 672 by friction in some embodiments. In other embodiments, additional elements may be used to secure the magnet in channel 672. In various embodiments, aperture 670 may comprise a C-shaped channel. The C-shaped channel may hold the magnet in place through friction.

FIG. 6B illustrates a conceptual representation of a coupling element 632 to moveably connect to a hinge pin 668 consistent with embodiments of the present disclosure. Coupling element 632 may be coupled to hinge pin 668 by moving coupling element 632 in the direction indicated by arrow 674. Coupling element 632 may expand and slide over hinge pin 668 till locked in place by the hinge receiving location of flame display element 618.

FIG. 6C illustrates a conceptual representation of coupling element 632 of FIG. 6B and consistent with embodiments of the present disclosure. Coupling element 632 may receive a magnet 634. Magnet 634 may be coupled with coupling element 632 by moving coupling element 632 in the direction indicated by arrow 674. Coupling element 632 may expand to receive magnet 634 and may retain magnet 634 by a friction fit.

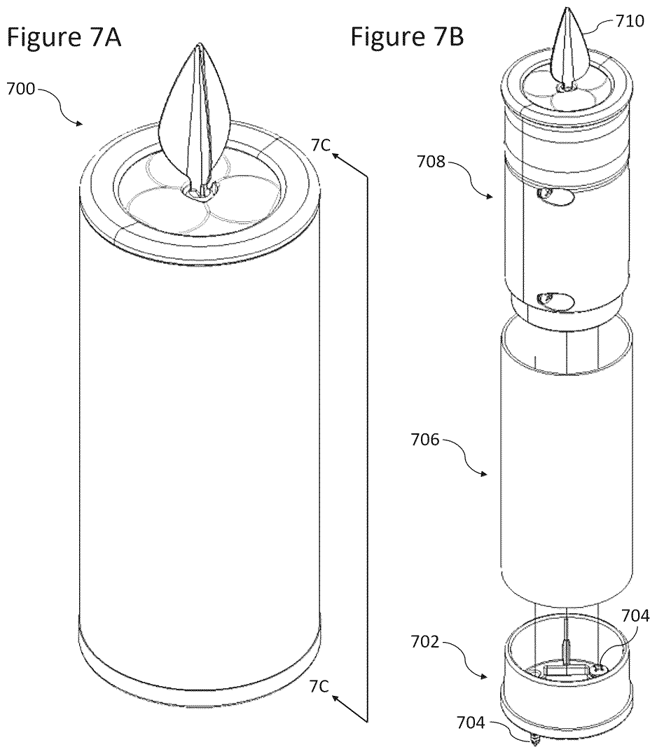

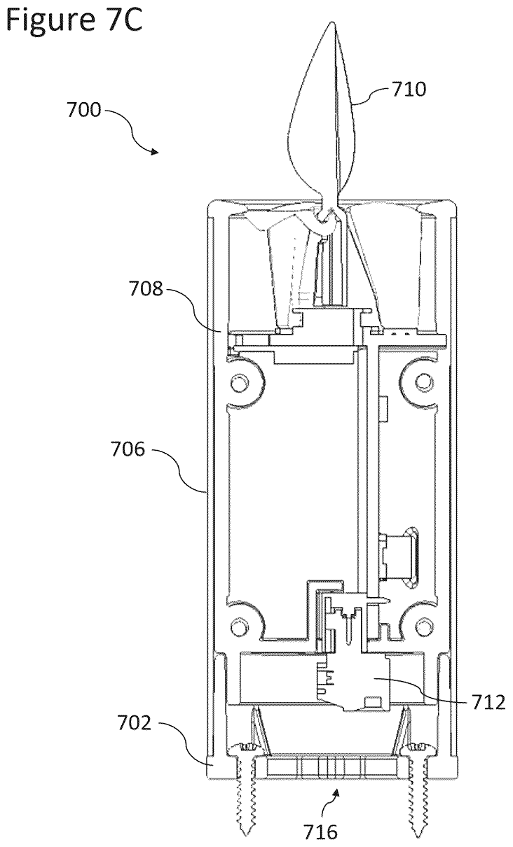

FIG. 7A illustrates a perspective view of freestanding lighting device 700 and consistent with embodiments of the present disclosure. Freestanding lighting device 700 may comprise a mounting base 702 that allows freestanding lighting device 700 to be affixed to a surface. A casing element 706 may create a uniform exterior. In some embodiments, casing element 706 may comprise decorative elements. A lighting device body 708 may also be enclosed within casing element 706.

FIG. 7B illustrates a partially exploded view of the freestanding lighting device of FIG. 7A consistent with embodiments of the present disclosure. Mounting base 702 may include features for securing freestanding lighting device 700 to a surface (e.g., a table). In the illustrated embodiment, mounting base 702 receives a plurality of screws 704. Other types of fasteners may be used in other embodiments.

Casing element 706 may receive mounting base 702. In the illustrated embodiment, a friction fit may be used to secure mounting base 702 to casing element 706. In other embodiments, other approaches may be used. For example, in one embodiment, threads may be disposed on the outer surface of mounting base 702 and may couple with corresponding threads disposed on the inside of casing element 706.

Lighting device body 708 may comprise a variety of lighting systems consistent with the present disclosure. Lighting device body 708 may include, among other things, a power subsystem, a control subsystem, a communication system, a movement subsystem, a lighting subsystem, etc. In some embodiments, lighting device body 708 may include elements that illuminate casing element 706 in addition to illuminating a flame display element 710.

FIG. 7C illustrates a cross-sectional view of the freestanding lighting device 700 illustrated in FIG. 7A and consistent with embodiments of the present disclosure. The relationship between mounting base 702, casing element 706, and lighting device body 708 discussed in connection with FIG. 7B is also illustrated in FIG. 7C. Specifically, casing element 706 surrounds mounting base 702 and lighting device body 708. Casing element 706 may provide a consistent outer surface and obscure the separations between mounting base 702 and lighting device body 708.

Freestanding lighting device 700 includes a connector 712. An opening 716 in mounting base 702 may allow access to connector 712. In one embodiment, connector 712 may receive input power and communication signal lines that allow freestanding lighting device 700 to be controlled by a controller. Input communication lines may consist of Digital Multiplex (DMX) and may coordinate the operation of a plurality of devices using one or more controllers. A variety of parameters (e.g., color, intensity, etc.) may be controlled using connector 712.

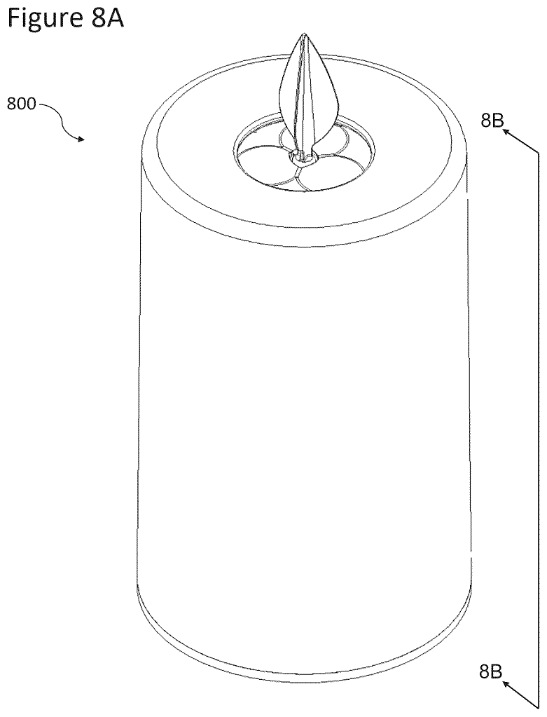

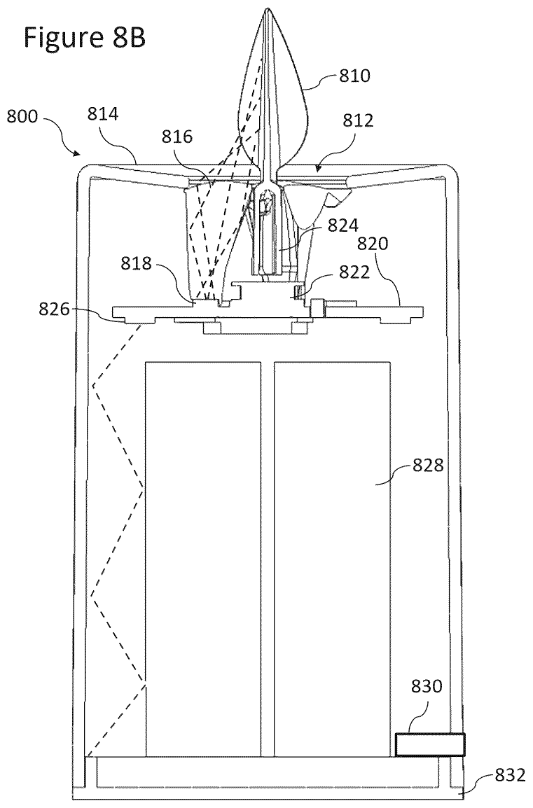

FIG. 8A illustrates a perspective view of a freestanding lighting device 800 consistent with embodiments of the present disclosure. Freestanding lighting device 800 may comprise a rechargeable power source that allows freestanding lighting device 800 to be used without being plugged into an external power supply. As discussed below, freestanding lighting device 800 may include elements to illuminate the base of freestanding lighting device 800 and to mimic the glow in the base of a candle caused by the flame.

FIG. 8B illustrates a cross-sectional view taken along line 8B of the freestanding lighting device illustrated in FIG. 8A and consistent with embodiments of the present disclosure. Freestanding lighting device 800 includes a flame display element 810 that emerges from an opening 816 in a body 814 of freestanding lighting device 800.

A printed circuit board 820 may connect a variety of components in freestanding lighting device 800. A light source 818 may be disposed on the top of printed circuit board 820. Light source 818 may direct light, which is illustrated using a plurality of dashed lines, to a lens 817, which in turn, directs light onto flame display element 810. Printed circuit board 820 may also include an electromagnet 822 disposed below flame display element 810 and operable to cause flame display element 810 to move. A magnet retention element 824 may house a magnet that interacts with electromagnet 822 to cause movement of flame display element 810.

Additional light elements, such as light element 826, may direct light downward toward body 814. At least a portion of body 814 may be translucent so that some light exits and mimics the appearance of a candle body illuminated by a flame.

One or more batteries 828 may be disposed in freestanding lighting device 800. The batteries may provide power to operate the various electrical devices (e.g., electromagnet 822, light source 818). In some embodiments, batteries 828 may comprise rechargeable batteries. A power port 830 may be used to provide power to freestanding lighting device 800. The power from power port 830 may be used to operate freestanding lighting device 800 and/or to recharge batteries 828.

A base 832 may couple with body 814 of freestanding lighting device 800. In some embodiments, base 832 may allow freestanding lighting device 800 to be secured to a surface. In various embodiments, base 832 may be separable from body 814 so that base 832 may be secured to a surface, and then body 814 may be joined to base 832. The mounting base may couple to the casing using one of a friction fit and a plurality of threads disposed on an inner surface of the casing and an outer surface of the mounting base

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A lighting device comprising:
a flame display element;
a power subsystem;
a lighting subsystem in electrical communication with the power subsystem to generate a light output, the lighting subsystem comprising at least one light source positioned below the flame display element;
a reflector positioned below the flame display element to collect and direct at least a portion of the light output upward and onto the flame display element,
a movement subsystem in electrical communication with the power subsystem and configured to move the flame display element to mimic a moving flame, and
a casing configured to enclose the reflector, power subsystem, lighting subsystem, and movement subsystem.

2. The lighting device of claim 1, wherein the lighting subsystem further comprises at least one additional light source to illuminate at least a portion of the casing.

3. The lighting device of claim 2, wherein at least a portion of the casing is at least partially translucent.

4. The lighting device of claim 2, wherein the portion of the light output to illuminate at least a portion of the casing varies over time to mimic a glow of a candle body.

5. The lighting device of claim 1, wherein the reflector utilizes total internal reflection to direct the light output from the lighting subsystem to the flame display element.

6. The lighting device of claim 1 further comprising a lens disposed between the reflector and the flame display element to direct at least a portion of the light output that extends through the lens inward and toward the flame display element.

7. The lighting device of claim 6, wherein the lens comprises a convex shape to direct the portion of the light output that extends through the lens inward toward the flame display element.

8. The lighting device of claim 6, wherein the lens comprises is comprised of discretized prismatic elements to direct the portion of the light output that extends through the lens.

9. The lighting device of claim 6, wherein the flame display element extends through an opening in the lens and the lens further comprises a hinge pin to couple to the flame display element.

10. The lighting device of claim 9, wherein the flame display element comprises a c-shaped channel to receive the hinge pin.

11. The lighting device of claim 10, wherein the flame display element comprises a magnet retention element.

12. The lighting device of claim 11, wherein the magnet retention element comprises a C-shaped channel to hold a magnet in place through friction.

13. The lighting device of claim 1, wherein a communication subsystem communicates with a controlling device via one of a hardwired and a wireless communication interface to establish at least one of a light color, a brightness, and a movement characteristic.

14. The lighting device of claim 1, further comprising a mounting base configured to secure the lighting device to a surface.

15. The lighting device of claim 14, wherein the mounting base couples to the casing using one of a friction fit and a plurality of threads disposed on an inner surface of the casing and an outer surface of the mounting base.

16. The lighting device of claim 1, wherein the lighting subsystem varies a color and an intensity of the light output over time.

17. The lighting device of claim 1, wherein the lighting subsystem, the at least one light source, and the movement subsystem are disposed on a printed circuit board.

18. The lighting device of claim 1, wherein the flame display element comprises three sides offset by approximately 120 degrees.

19. The lighting device of claim 1, wherein the power subsystem comprises one or more batteries disposed within the casing.

20. The lighting device of claim 1, further comprising a connector accessible through an opening in the mounting base, the connector configured to receive input power and an input communication line.
